(19) United States
(12) Patent Application Publication
(10) Pub. No.: US 2026/0175811 A1
(43) Pub. Date: Jun. 25, 2026

(54) SEAT BOTTOM MOUNTED AIRBAG ASSEMBLY

(71) Applicant: Ford Global Technologies, LLC, Dearborn, MI (US)

(72) Inventors: Raed Essa EL-Jawahri, Hopkinton, MA (US); Anil Kalra, Canton, MI (US); Kevin Michael Pline, Plymouth, MI (US); Robert William McCoy, Ann Arbor, MI (US); Kevin Siasoco, Ann Arbor, MI (US); Derek Board, Oakland, MI (US)

(73) Assignee: Ford Global Technologies, LLC, Dearborn, MI (US)

(21) Appl. No.: 18/989,278

(22) Filed: Dec. 20, 2024

(51) Int. Cl. B60R 21/2338; B60R 21/00; B60R 21/207

(52) U.S. Cl. CPC B60R 21/2338; B60R 21/207; B60R 2021/0053; B60R 2021/23386

(57) ABSTRACT

A vehicle seat includes a seat bottom and an airbag supported by the seat bottom. The airbag is inflatable to an inflated position. The airbag in the inflated position includes a middle portion extending seat-forward from the seat bottom. The airbag in the inflated position includes a first forward portion extending laterally from the middle portion. The first forward portion is spaced from the seat bottom. The airbag in the inflated position includes a first wing portion spaced from the middle portion and extends seat-rearward from the first forward portion. The airbag includes an inflation chamber extending in the middle portion, the first forward portion, and the first wing portion.

### BACKGROUND

A vehicle may include amenities that allow occupants to face one another during operation of the vehicle. As one example, an autonomous vehicle may be autonomously operated, allowing occupants of the vehicle to ride in the vehicle without monitoring the operation of the vehicle. Specifically, the vehicle may include seats that face each other or are free to rotate to positions facing each other.

### BRIEF DESCRIPTION OF THE DRAWINGS

FIG. 1 is a cutaway view of a vehicle with airbags each in an uninflated position.

FIG. 2 is a cutaway view of the vehicle with some airbags in an inflated position.

FIG. 3 is a magnified view of a portion of FIG. 2.

FIG. 4 is a top view of the vehicle with some of the airbags in the inflated position and some airbags in the uninflated position.

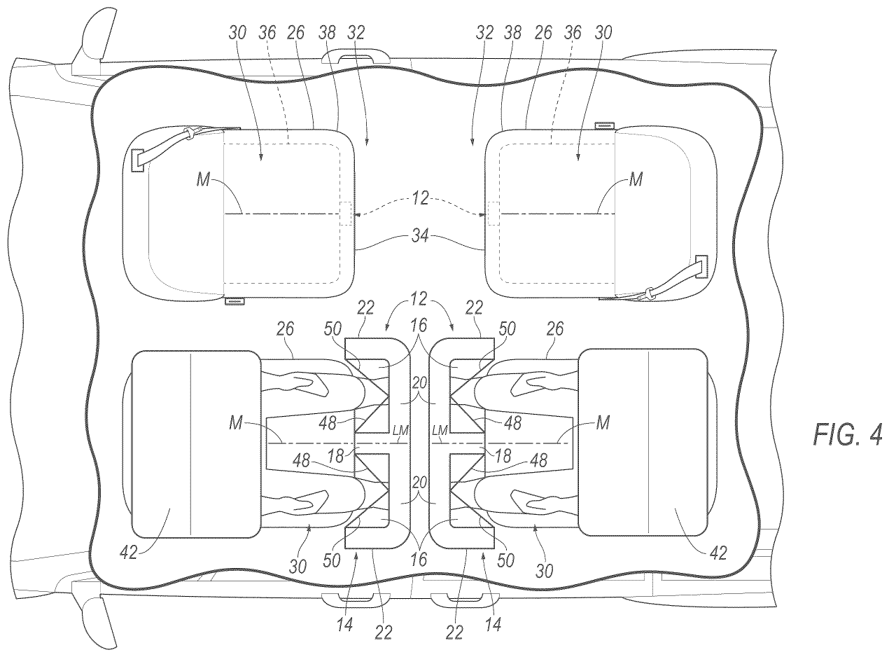

FIG. 5 is a magnified view of a portion of FIG. 4.

### DETAILED DESCRIPTION

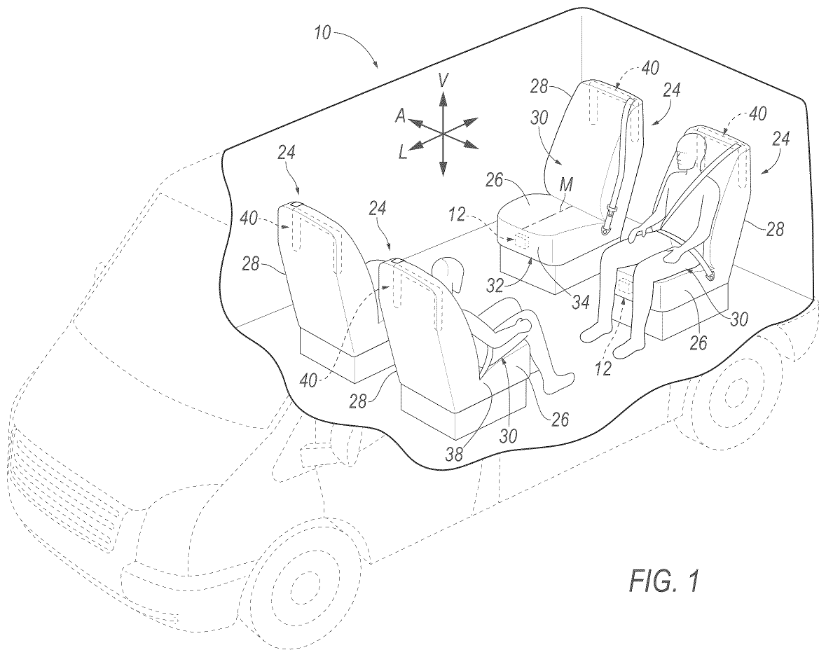

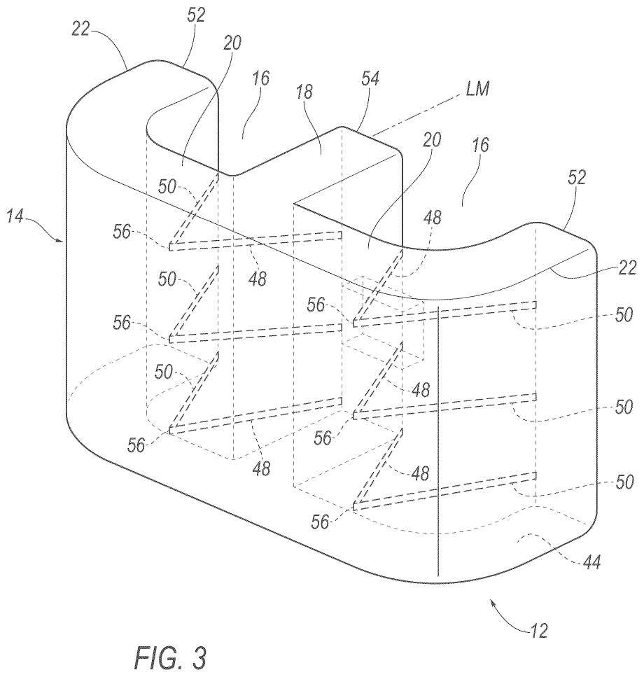

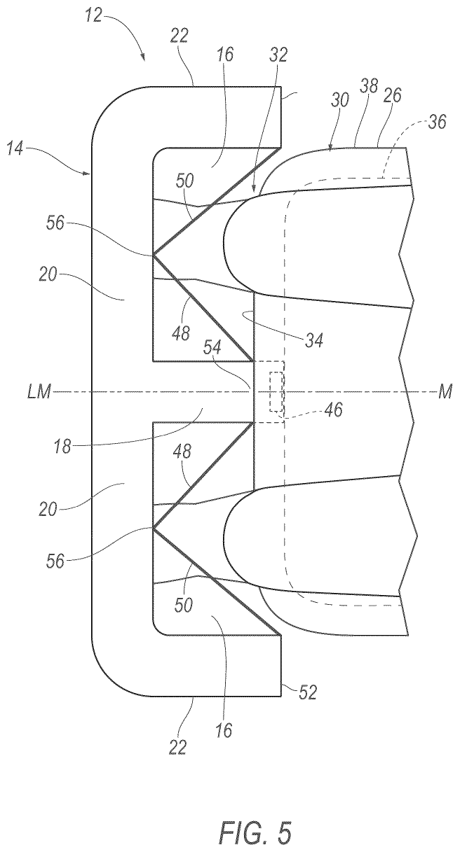

With reference to the Figures, wherein like numerals indicate like parts throughout the several views, an airbag assembly (specifically a leg-airbag assembly 12) for a vehicle 10 includes an airbag (specifically a leg airbag 14) inflatable from an uninflated position to an inflated position. The leg airbags 14 in FIG. 1 are in the uninflated position and the leg airbag 14 in FIGS. 3 and 5 is in the inflated position. The leg airbag 14 in the inflated position has an occupant-leg cavity 16. The leg airbag 14 in the inflated position includes a middle portion 18 extending along the occupant-leg cavity 16. The middle portion 18 has a longitudinal axis and is elongated along the longitudinal axis. The leg airbag 14 in the inflated position includes a forward portion 20 extending along the occupant-leg cavity 16 from the middle portion 18 transverse to the longitudinal axis. The leg airbag 14 in the inflated position includes a wing portion 22 spaced from the middle portion 18. The wing portion 22 extends along the occupant-leg cavity 16 from the forward portion 20 along the longitudinal axis. The leg airbag 14 includes an inflation chamber 44 extending in the middle portion 18, the forward portion 20, and the wing portion 22.

The vehicle 10 includes a seat 24 including a seat bottom 26, and the seat bottom 26 includes the leg-airbag assembly 12. The leg-airbag assembly 12 is supported by the seat bottom 26. In the inflated position, the middle portion 18 of the leg airbag 14 extends seat-forward from the seat bottom 26. The first forward portion 20 is spaced from the seat bottom 26.

During inflation of the airbag, the airbag deploys between the legs of the occupant. In the inflated position, the middle portion 18 is disposed between the legs of the occupant. Specifically, the middle portion 18 is inboard of one of the legs of the occupant, the forward portion 20 extends in front of that leg of the occupant, and the wing portion 22 extends outboard of that leg of the occupant. In such a position, the airbag controls the kinematics of that leg of the occupant.

In the example shown in the Figures, the leg airbag 14 in the inflated position has a second occupant-leg cavity 16, a second forward portion 20 extending along the second occupant-leg cavity 16 from the middle portion 18 transverse to the longitudinal axis, and a second wing portion 22 extending along the second occupant-leg cavity 16. In such an example, in the inflated position, one occupant-leg cavity 16 is designed to receive one leg of an occupant of the seat 24 and the other occupant-leg cavity 16 is designed to receive the other leg of the occupant of the seat 24. In such an example, the airbag controls the kinematics of both legs of the occupant. The numerical adjectives “first” and “second” are used throughout this document as identifiers and do not indicate order or importance.

The vehicle 10 may be any suitable type of automobile, e.g., a passenger or commercial automobile such as a sedan, a coupe, a truck, a sport utility, a crossover, a van, a minivan, a taxi, a bus, etc. The vehicle 10 defines an occupant cabin. With reference to FIG. 1, the vehicle 10 defines a vehicle fore-and-aft axis L extending between a front end (not numbered) and a rear-end (not numbered) of the vehicle 10. In some examples, the vehicle 10 is elongated along the vehicle fore-and-aft axis. The vehicle 10 defines a cross-vehicle axis A extending cross-vehicle from one side to the other side of the vehicle 10. The vehicle 10 defines a vertical axis V extending through a floor and roof of the vehicle 10. The vehicle fore-and-aft axis L, the cross-vehicle axis C, and the vertical axis V are perpendicular relative to each other.

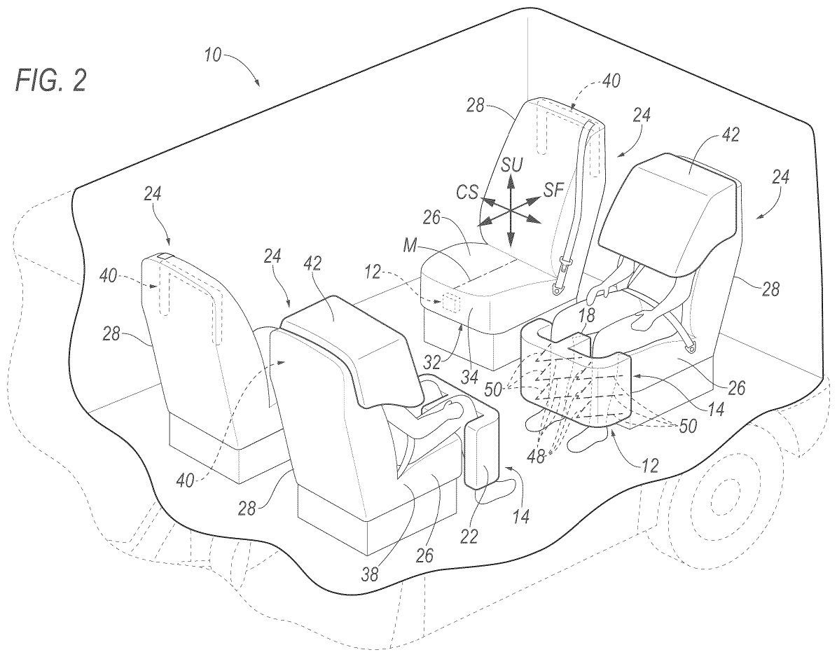

The vehicle 10 includes one or more seats 24 in the occupant cabin. The vehicle 10 may include any suitable number of seats 24. The seats 24 may be arranged in the occupant cabin in any suitable position, i.e., as front seats, rear seats, third-row seats, etc. The seat 24 may be movable relative to the floor to various positions, e.g., movable fore-and-aft and/or cross-vehicle. The seats 24 may be of any suitable type, e.g., a bucket seat. In the example shown in FIGS. 1 and 2, the vehicle 10 includes four seats, and each seat 24 includes at least one leg-airbag assembly 12. In other examples, the vehicle 10 may include any suitable number of seats 24, and any one or more of the seats 24 may include one or more leg-airbag assemblies.

The seat 24 includes a seatback 28 and the seat bottom 26. The seatback 28 may be supported by the seat bottom 26 and may be stationary or movable relative to the seat bottom 26. The seatback 28 and the seat bottom 26 may be adjustable in multiple degrees of freedom. Specifically, the seatback 28 and the seat bottom 26 may themselves be adjustable, in other words, adjustable components within the seatback 28 and/or the seat bottom 26, and/or may be adjustable relative to each other.

The seat 24, specifically the seatback 28 and the seat bottom 26, define an occupant-seating area 30. The occupant-seating area 30 is the space occupied by an occupant properly seated on the seat 24. The occupant-seating area 30 is seat-forward of the seatback 28 and above the seat bottom 26. The occupant-seating area 30 is on a front side of the seatback 28. The occupant-seating area 30 includes a leg area 32 that is seat forward of the seat bottom 26. The seat bottom 26 defines the leg area 32. In other words, a forward face 34 of the seat bottom 26 bounds the leg area 32. The leg area 32 is configured to receive the legs of an occupant of the seat 24 when the occupant is properly seated in the seat 24.

In some examples, one or more of the seats 24 may be swivelable. In other words, the seat 24 may be selectively swiveled by the occupant of the seat 24 to different facing positions. Specifically, each seat 24 is rotatably mounted to the floor and may rotate about a seat-upright axis that extends through the roof and the floor. For example, the seats 24 may rotate between a forward-facing position, a rearward-facing position, a rightward-facing position, a leftward-facing position, and/or positions therebetween. In the forward-facing position, an occupant of the seat 24 faces a front dash, and in the rearward-facing position, an occupant of the seat 24 faces in an opposite direction toward the rear of the occupant cabin. In the example shown in FIGS. 1 and 2, two of the seats 24 are in the forward-facing position and two of the seats 24 are in the rearward-facing position. The seats 24 may rotate completely, i.e., 360°, about the vertical axis. The seats 24 may rotate between fixed positions, e.g., the forward-facing position and the rearward-facing position, or may be rotatable to an infinite number of positions. In some examples, one or more of the seats 24 may be fixed in a single facing direction.

In examples in which the seat 24 is swivelable, the seat 24 may include a base, and the seat bottom 26 may be rotatably mounted to the base. The base may include, for example, a rotating track, a rotating pedestal, etc., for rotation, i.e., swiveling, of the seat bottom 26 relative to the base. The base may be fixed to the floor, e.g., directly fixed to the floor.

The seat 24 defines a seat-forward direction. The seat-forward direction extends forward relative to the seat 24. For example, the seat-forward direction may extend from a rear of the seat 24 to a front of the seat 24 relative to an occupant of the seat 24, i.e., the occupant of the seat 24 faces in the seat-forward direction when properly seated in the seat 24. The seat bottom 26 extends from the seatback 28 in the seat-forward direction. The seat 24 defines a fore-and-aft axis SF, a cross-seat axis CS, and a seat-upright axis SU. A seat-forward direction extends in parallel with the fore-and-aft axis SF. A cross-seat direction extends in parallel with the cross-seat axis CS. The seat-forward axis, the cross-seat axis CS, and the seat-upright axis SU are perpendicular to each other. The fore-and-aft axis SF is parallel with the vehicle fore-and-aft axis L when the seat 24 is forward facing and when the seat 24 is rearward facing, the cross-seat axis CS is parallel with the cross-vehicle axis when the seat 24 is forward facing and when the seat 24 is rearward facing, and the seat-upright axis SU extends through the vehicle floor and the vehicle roof when the seatback 28 is in an upright position. The seat 24 includes a first side and a second side. The first side is spaced from the second side along the cross-seat axis CS.

The seat bottom 26 has a rearward end at the seatback 28 and a forward face 34 distal to the seatback 28. The forward face 34 is the face of the seat bottom 26 distal-most to seatback 28. The forward face 34 may be generally vertical and may be elongated cross seat. The leg area 32 of the occupant-seating area 30 is seat forward of the forward face 34. When the leg airbag 14 is in the inflated position, the leg area 32 is between the leg airbag 14 and the forward face 34.

The seat bottom 26 includes a midline M between the first side and the second side. The midline M is equidistantly spaced from the first side and the second side along the cross-seat axis CS. In other words, the midline M is a cross-seat midline M. The midline M is parallel to the fore-and-aft axis SF of the seat 24. As set forth below, the middle portion 18 of the leg airbag 14 of the seat 24 is aligned with and elongated along the midline M.

The seat bottom 26 and the seatback 28 each include a frame 36 and a covering 38 supported on the frame 36. The frame 36 may include tubes, beams, etc. The frame may be of any suitable material such as plastic (e.g., carbon fiber reinforced plastic (CFRP), glass fiber-reinforced semi-finished thermoplastic composite (organosheet), etc.) and/or metal (e.g., steel, aluminum, etc.). The covering 38 of the seat 24 may include upholstery and padding. The upholstery may be cloth, leather, faux leather, or any other suitable material. The upholstery may be stitched in panels around the frame 36. The padding may be between the covering and the frame 36 and may be foam or any other suitable material.

The seatback 28 may have bolsters on opposite sides of the occupant-seating area 30. One of the bolsters is on the first side of the seat 24 and the other of the bolsters is on the second side of the seat 24. The bolsters are elongated, and specifically, are elongated generally upright when the seatback 28 is in a generally upright position. The bolsters define cross-seat boundaries of the seatback 28, i.e., the seatback 28 terminates at the bolsters. The bolsters may extend in a seat-forward direction relative to the rest of the seatback 28 on opposite sides of the torso and shoulders of an occupant seated on the seat 24.

The vehicle 10 includes a seatbelt assembly for each seat 24. The seatbelt assembly may be a three-point harness, meaning that the webbing is attached at three points around the occupant when fastened: an anchor, a seatbelt retractor, and a buckle. The seatbelt assembly may, in other examples, include another arrangement of attachment points.

Each seat 24 may include one leg-airbag assembly 12 and each seat 24 may include an upper-airbag assembly 40 including an upper airbag 42. In the event a certain vehicle impact is detected, the leg-airbag assembly 12 and/or the upper-airbag assembly 40 may be inflated from the uninflated position, as shown in FIG. 1, to an inflated position, as shown for some airbags in FIG. 2. The leg airbag 14 in the inflated position is shown in FIGS. 3 and 5. In some examples, the leg-airbag assembly 12 and the upper-airbag assembly 40 of a seat 24 may be independently inflatable, e.g., based on characteristics of the vehicle impact such as direction, magnitude, etc. The leg airbag 14 of a seat 24 is designed to inflate seat forward of legs of an occupant of the seat 24 so that the leg area 32 is between the leg airbag 14 and the seat bottom 26. The upper airbag 42 of a seat 24 is designed to inflate seat forward of an upper portion of an occupant of the seat 24 so that an upper area of the occupant-seating area 30 is between the upper airbag 42 and the seatback 28. The upper airbag 42 is designed to control the kinematics of an upper portion of the body of the occupant, and the leg airbag 14 is designed to control the kinematics of the legs of the occupant.

The upper-airbag assembly 40 includes the upper airbag 42. The upper-airbag assembly 40 includes an inflator 46 and may include a housing. The inflator 46 of the upper-airbag assembly 40 inflates the upper airbag 42 to the inflated position.

The upper airbag 42 is mounted to the seatback 28. Specifically, the upper airbag 42 is mounted to the frame 36 of the seatback 28. The upper airbag 42 is supported by the seatback 28 in the uninflated position and the in the inflated position, i.e., the weight of the upper airbag 42 is borne by the seatback 28 (such as the frame 36 of the seatback 28) in the uninflated position and in the inflated position. In examples in which the upper-airbag assembly 40 includes the housing, the housing houses the upper airbag 42 in the uninflated position and supports the upper airbag 42 in the inflated position. The upper airbag 42 may be rolled and/or folded to fit within the housing in the uninflated position. The housing may be of any suitable material, e.g., a rigid polymer, a metal, a composite, or a combination of rigid materials. The airbag housing of the upper-airbag assembly 40 may, for example, include clips, threaded fasteners, etc., for attaching the housing to the seatback 28. In other examples, the upper airbag 42 may be mounted directly to the frame 36 of the seatback 28, i.e., without a housing. In such an example, the upper airbag 42 may be rolled and/or folded beneath the cover of the seatback 28.

The upper airbag 42 is inflatable from the seatback 28 to the inflated position. The covering 38 of the seatback 28 may include a tear seam through which the upper airbag 42 breaks when the upper airbag 42 is inflated from the uninflated position to the inflated position. As set forth above, the upper airbag 42 may be designed such that the upper area of the occupant-seating area 30 is between the upper airbag 42 and the seatback 28 when the upper airbag 42 is in the inflated position. The upper airbag 42 may be designed to control the kinematics of the upper portion of the occupant during certain vehicle impacts. The upper airbag 42 may include external tethers, tether retractors, etc., to deploy the upper airbag 42.

The upper airbag 42 may be fabric, e.g., a woven polymer yarn. The woven polymer yarn may be, for example, nylon 6, 6. Other examples of the woven polymer yarn include polyether ether ketone (PEEK), polyetherketoneketone (PEKK), polyester, etc. The woven polymer yarn may include a coating, such as silicone, neoprene, urethane, etc. For example, the coating may be polyorgano siloxane.

The inflator 46 of the upper-airbag assembly 40 is in fluid communication with the upper airbag 42. The inflator 46 expands an inflation chamber of the upper airbag 42 with inflation medium, such as a gas, to move the upper airbag 42 from the uninflated position to the inflated position. In some examples, the inflator 46 may be fixed to (e.g., with threaded fasteners, straps, etc.) and supported by the frame 36 of the seatback 28. In such an example, the inflator 46 may be, for example, at least partially in the inflation chamber of the upper airbag 42 to deliver inflation medium directly to the inflation chamber of the upper airbag 42 or may be connected to the inflation chamber of the upper airbag 42 through fill tubes, diffusers, etc. The inflator 46 may be, for example, a pyrotechnic inflator 46 that ignites a chemical reaction to generate the inflation medium, a stored gas inflator 46 that releases (e.g., by a pyrotechnic valve) stored gas as the inflation medium, or a hybrid. In some examples, the seat 24 may include a single inflator 46 that selectively inflates both the upper airbag 42 and leg airbag 14.

The leg-airbag assembly 12 includes the leg airbag 14. The leg-airbag assembly 12 includes an inflator 46 and may include a housing. The inflator 46 inflates the leg airbag 14 to the inflated position, as described further below.

The leg airbag 14 is mounted to the seat bottom 26. Specifically, the leg airbag 14 is mounted to the frame 36 of the seat bottom 26. The leg airbag 14 is supported by the seat bottom 26 in the uninflated position and the in the inflated position, i.e., the weight of the leg airbag 14 is borne by the seat bottom 26 (for example the frame 36 of the seat bottom 26) in the uninflated position and in the inflated position. In examples in which the leg-airbag assembly 12 includes the housing, the housing houses the leg airbag 14 in the uninflated position and supports the leg airbag 14 in the inflated position. The leg airbag 14 may be rolled and/or folded to fit within the housing in the uninflated position. The housing may be of any suitable material, e.g., a rigid polymer, a metal, a composite, or a combination of rigid materials. The airbag housing of the leg-airbag assembly 12 may, for example, include clips, threaded fasteners, etc., for attaching the housing to the seat bottom 26. In other examples, the leg airbag 14 may be mounted directly to the frame 36 of the seat bottom 26, i.e., without a housing. In such an example, the leg airbag 14 may be rolled and/or folded beneath the cover of the seat bottom 26. The leg airbag 14 in the uninflated position may be on the midline M of the seat bottom 26. For example, the leg airbag 14 may be mounted to the frame 36 of the seat bottom 26 on the midline M of the seat bottom 26.

The leg airbag 14 is inflatable from the seat bottom 26 to the inflated position. The leg airbag 14, specifically the middle portion 18, inflates from the forward face 34 of the seat bottom 26 in parallel with the midline M. The cover of the seat bottom 26 may include a tear seam through which the leg airbag 14 breaks when the leg airbag 14 is inflated from the uninflated position to the inflated position.

In the example shown in the Figures, the leg airbag 14 includes a middle portion 18, two forward portions 20 extending in opposite directions from the middle portion 18, and two wing portions 22 extending from the two front portions, respectively. As set forth above, the numerical adjectives “first” and “second” used herein, including with reference to the front portions and the wing portions 22, are identifiers and do not indicate order or importance. The middle portion 18, the forward portions 20, and the wing portions 22 are unitary, i.e., are connected to each other and move together as a unit when the leg airbag 14 inflates. In some examples, the middle portion 18, the forward portions 20, and the wing portions 22 may be formed as a single, uniform piece of material with no seams, e.g., by one-piece weaving. In other examples, the middle portion 18, the forward portions 20, and the wing portions 22 may be unitary by joints that are stitched, adhered, welded, etc.

The leg airbag 14 in the inflated position has two occupant-leg cavities 16. Each occupant-leg cavity 16 is designed to receive one leg of the occupant when the occupant is properly seated in the seat 24. The leg airbag 14 separates the leg area 32 into the two occupant-leg cavities 16, as described further below. Each front portion and respective wing portion 22 define one of the occupant-leg cavities 16.

The front portions and the wing portions 22 are in fluid communication with the middle portion 18. Specifically, the airbag has an inflation chamber 44 that extends in the middle portion 18, the front portions, and the wing portions 22. The inflator 46 provides inflation medium to the inflation chamber 44 of the middle portion 18, and the inflation medium flows from the middle portion 18 to the inflation chambers 44 of the forward portions 20 and from the forward portions 20 to the respective inflation chambers 44 of the wing portions 22. In some examples, the forward portions 20 can be in fluid communication with each other across the middle portion 18 where the forward portions 20 meet the middle portion 18. The leg airbag 14 may include internal tethers to define and/or maintain the shape of the middle portion 18, the front portions, and/or the wing portions 22 in the inflated position.

Since the middle portion 18, the forward portions 20, and the wing portions 22 of the airbag sequentially inflate to the inflated position, the airbag inflates around the legs of the occupant in the leg area 32 of the seat 24 with each occupant-leg cavity 16 receiving one of the legs of the occupant. Specifically, the inflation of the middle portion 18 to the inflated position spaces the forward portions 20 and the wing portions 22 from the forward face 34 of the seat bottom 26 so that the forward portions 20 and the wing portions 22 are forward of the legs of the occupant in the leg area 32 in the seat-forward direction. When the middle portion 18 is in the inflated position and the forward portions 20 continue to inflate, the forward portions 20 extend in cross-seat directions seat forward of the leg areas 32, respectively, of the seat 24 and the legs, respectively, of the occupant properly seated in the seat 24. The inflation of the forward portions 20 to the inflated position moves the wing portions 22 in the cross-seat directions. When the forward portions 20 are in the inflated position and the wing portions 22 continue to inflate, the wing portions 22 extend seat rearward. The middle portion 18, the forward portions 20, and the wing portions 22 in the inflated position create the occupant-leg cavities 16 that receive the legs of the occupant.

In the inflated position, the middle portion 18 is supported by the seat bottom 26, the forward portions 20 are supported by the middle portion 18, and the wing portions 22 are supported by the respective forward portions 20. In other words, the weight of the middle portion 18 is borne by the seat bottom 26, the weight of both forward portions 20 is borne by the middle portion 18, and the weight of both wing portions 22 is borne by forward portions 20. The forward portions 20 are supported by the seat 24 through the middle portion 18. The wing portions 22 are supported by the seat 24 through the respective forward portion 20 and the middle portion 18.

In some examples, the inflator 46 of the leg-airbag assembly 12 inflates the middle portion 18 directly. In other words, inflation medium flows from the inflator 46 to the middle portion 18 and flows to the forward portions 20 and the wing portions 22 through the middle portion 18. Specifically, in such an example, the inflation medium flows from the inflator 46 to the middle portion 18, from the middle portion 18 to the forward portions 20, and from the forward portions 20 to the respective wing portions 22.

The middle portion 18 of the leg airbag 14 extends in the seat-forward direction from the seat bottom 26 in the inflated position. The middle portion 18 may be elongated along the fore- and -aft axis SF in the inflated position, i.e., the longest dimension of the middle portion 18 may be in the seat-forward direction. Specifically, in the example shown in the Figures, the middle portion 18 has a longitudinal axis LM. The middle portion 18 is elongated along the longitudinal axis LM of the middle portion 18. In the example shown in the Figures, the longitudinal axis LM is parallel to the midline M of the seat bottom 26 and is parallel to the fore-and-aft axis SF of the seat 24.

As set forth above, the middle portion 18 may inflate from the forward face 34 of the seat bottom 26 in a seat-forward direction in parallel with the midline M. The middle portion 18 extends into the leg area 32 in the inflated position. Specifically, the middle portion 18 is designed to extend between the legs of the occupant of the seat 24. The middle portion 18 in the inflated position bisects the leg area 32.

Both forward portions 20 extend laterally from the middle portion 18 in the inflated position, i.e., extend outwardly from a side of the middle portion 18. Specifically, both forward portions 20 extend from the middle portion 18 transverse to the middle portion 18 in the inflated position. In the example shown in the Figures the forward portion 20 extends perpendicular to the middle portion 18 in a cross-seat direction, i.e., a direction parallel to the cross-seat axis CS. The forward portions 20 may be elongated along the cross-seat direction. The forward portions 20 are seat-forward of the seat bottom 26 in the inflated position. Specifically, as set forth below, the forward portions 20 are spaced from a front end of the seat bottom 26. The forward portions 20 may each extend from the middle portion 18 in a direction parallel to the forward face 34 of the seat bottom 26. In such examples, the forward portions 20 may be elongated along axes parallel to the forward face 34 of the seat bottom 26.

The forward portions 20 may be elongated along colinear axes. In such an example, the forward portions 20 are aligned longitudinally along the middle portion 18, i.e., extend laterally from the middle portion 18 at a common location along a longitudinal axis of the middle portion 18.

The wing portions 22 are spaced from the middle portion 18 in cross-seat directions, respectively, and extend from the respective forward portion 20 in a seat rearward direction, e.g., toward the seat bottom 26, in the inflated position. In the example shown in the Figures the wing portions 22 extend perpendicular to the respective forward portions 20 in a seat-rearward direction. The wing portions 22 may be elongated along the fore-and-aft axis SF, as shown in the Figures. In such examples, the wing portions 22 extend from the respective forward portions 20 along axes parallel to the longitudinal axis LM of the middle portion 18.

The leg airbag 14 has a top surface that is higher than the seat bottom 26 to control the kinematics of the lower legs of the occupant. Specifically, the seat bottom 26 has a top surface, and the top surface of the seat bottom 26 at the leg area 32, i.e., at a front side of the seat bottom 26, is lower than the top surface of the forward portions 20 of the airbag in the inflated position.

The leg airbag 14 may be fabric, e.g., a woven polymer yarn. The woven polymer yarn may be, for example, nylon 6, 6. Other examples of the woven polymer yarn include polyether ether ketone (PEEK), polyetherketoneketone (PEKK), polyester, etc. The woven polymer yarn may include a coating, such as silicone, neoprene, urethane, etc. For example, the coating may be polyorgano siloxane.

The inflator 46 of the leg-airbag assembly 12 is in fluid communication with the leg airbag 14. The inflator 46 expands the leg airbag 14 with inflation medium, such as a gas, to move the airbag from the uninflated position to the inflated position. In some examples, the inflator 46 may be fixed to (e.g., with threaded fasteners, straps, etc.) and supported by the frame 36 of the seat bottom 26, as shown in the example in the Figures. In such an example, the inflator 46 may be, for example, at least partially in the inflation chamber 44 to deliver inflation medium directly to the inflation chamber 44 or may be connected to the inflation chamber 44 through fill tubes, diffusers, etc. The inflator 46 may be, for example, a pyrotechnic inflator 46 that ignites a chemical reaction to generate the inflation medium, a stored gas inflator 46 that releases (e.g., by a pyrotechnic valve) stored gas as the inflation medium, or a hybrid.

The leg airbag 14 may include external tethers 48, 50 in the occupant-leg cavities 16. The external tethers 48, 50 extend external to the inflation chamber 44 of the leg airbag 14. In the example, shown in the Figures, the leg airbag 14 includes multiple tethers 48, 50 in each occupant-leg cavity 16. The tethers are referred to hereinafter as inboard tethers 48 and outboard tethers 50, as described further below. Each outboard tether 50 extends across the respective occupant-leg cavity 16 from the forward portion 20 to the wing portion 22. Each inboard tether 48 extends across the respective occupant-leg cavity 16 from the forward portion 20 to the middle portion 18.

The tethers 48, 50 are fixed to the leg airbag 14 in the uninflated position and in the inflated position. Specifically, each outboard tether 50 is fixed to the respective forward portion 20 and wing portion 22, and each inboard tether 48 is fixed to the respective forward portion 20 and middle portion 18. The tethers 48, 50 are fixed to the leg airbag 14 by, for example, stitching, adhesive, welding, etc. The tethers 48, 50 move with the leg airbag 14 as a unit as the leg airbag 14 inflates from the uninflated position to the inflated position.

The outboard tethers 50 transmit force from the respective wing portion 22 to the respective forward portion 20 to resist outboard rotation of the wing portion 22 when the leg airbag 14 is in the inflated position. The inboard tethers 48 transmit force from the respective forward portion 20 to the middle portion 18 to resist forward rotation of the forward portion 20 relative to the middle portion 18 when the leg airbag 14 is in the inflated position. In examples in which the leg airbag 14 includes an inboard tether 48 and an outboard tether 50 in the same occupant-leg cavity 16, the inboard tether 48 and the outboard tether 50, in conjunction, resist forward and outboard rotation of the forward portion 20 and wing portion 22.

In examples in which the leg airbag 14 includes an inboard tether 48 and an outboard tether 50 in the same occupant-leg cavity 16, the inboard tether 48 and the outboard tether 50 may be vertically aligned. In such examples, the leg airbag 14 may include multiple pair of tethers with each pair including an inboard tether 48 and an outboard tether 50 vertically aligned with each other. The pairs of tethers 48, 50 may be vertically spaced from each other, as shown in the example in the Figures.

In examples in which the leg airbag 14 includes an inboard tether 48 and an outboard tether 50 in the same occupant-leg cavity 16, the inboard tether 48 and outboard tether 50 may meet at the respective forward portion 20. In such an example, including in the example shown in the Figures, the inboard tether 48 and the outboard tether 50 form a V-shape when the airbag is in the inflated position. The V-shape of the inboard tether 48 and the outboard tether 50 when the leg airbag 14 is in the inflated position is designed to receive the leg of the occupant. For example, a vertex 56 at which the inboard tether 48 and the outboard tether 50 meet is positioned to receive the leg of the occupant and/or the angle of the inboard tether 48 and the outboard tether 50 at the vertex 56 is positioned to receive the leg of the occupant. In some examples, the vertex 56 may be at a midpoint of an inner surface of the forward portion 20 that extends between the middle portion 18 and the wing portion 22.

In some examples, including the example shown in the Figures, the inboard tethers 48 may be fixed to a rearward end 52 of the wing portion 22 and the outboard tethers 50 may be fixed to a rearward end 54 of the middle portion 18. The rearward ends 52, 54 of the wing portion 22 and the middle portion 18 are the ends of the wing portion 22 and the middle portion 18 closest to the seat bottom 26. In the example shown in the Figures, the tethers 48, 50 are generally horizontal when the leg airbag 14 is in the inflated position. In other examples, the tethers 48, 50 may angle upwardly or downwardly from the middle portion 18.

The inboard tether 48 and the outboard tether 50 of a pair of tethers may abut each other at the vertex 56. In some examples, the inboard tether 48 and the outboard tether 50 can be unitary. In such examples, the inboard tether 48 and the outboard tether 50 may be formed as a single, uniform piece of material with no seams, e.g., by one-piece weaving, cutting from a single blank of material, etc. In other examples, the inboard tether 48 and the outboard tether 50 may be unitary by joints that are stitched, adhered, welded, etc.

The tethers 48, 50 are flexible so that the tethers can be folded when the leg airbag 14 is in the uninflated position and become taught when the leg airbag 14 is in the inflated position. The tethers 48, 50 may be fabric, yarn, string, etc. In some examples, the tethers 48, 50 may be of the same material type as the airbag, e.g., fabric such a woven polymer yarn.

The vehicle 10 may include a computer having a processor and a memory storing instructions executable by the processor to deploy the airbag. The computer may be, for example, a restraints control module. Use of “in response to” and “based on” herein indicates a causal relationship, not merely a temporal relationship.

The vehicle computer includes a processor and a memory such as are known. The memory includes one or more forms of computer readable media, and stores instructions executable by the vehicle computer for performing various operations, including as disclosed herein.

Via a vehicle network, the computer may transmit messages to various devices in the vehicle 10 and/or receive messages (e.g., CAN messages) from the various devices, e.g., sensors, the actuator, the inflator 46, a human machine interface (HMI), etc. Alternatively or additionally, in cases where the computer includes a plurality of devices, the vehicle communication network may be used for communications between devices represented as the computer in this disclosure. Further, as mentioned below, various controllers and/or sensors may provide data to the computer via the vehicle communication network. The communication network can include a bus in the vehicle 10 such as a controller area network (CAN) or the like, and/or other wired and/or wireless mechanisms.

The computer is a microprocessor-based controller implemented via circuits, chips, or other electronic components. The computer includes a processor and a memory. The memory includes one or more forms of computer readable media, and stores instructions executable by the computer for performing various operations, including as disclosed herein. The computer may be programmed to execute operations disclosed herein. The memory stores instructions executable by the processor to execute the operations disclosed herein and electronically stores data and/or databases. For example, the computer may include one or more dedicated electronic circuits including an ASIC (Application Specific Integrated Circuit) that is manufactured for a particular operation. In another example, the computer may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g., stored in a memory electrically connected to the FPGA circuit. In some examples, a combination of processor(s), ASIC(s), and/or FPGA circuits may be included inside a chip packaging. The computer may be a set of computers communicating with one another.

The vehicle 10 may include at least one impact sensor for sensing certain vehicle impacts (e.g., impacts of a certain magnitude, direction, etc.), and the computer is in communication with the impact sensor, the actuator of the deployment assembly, and the inflator 46. The computer may activate the inflator 46, e.g., provide an impulse to a pyrotechnic charge of the inflator 46 when the impact sensor senses certain vehicle impacts. The impact sensor may be configured to sense certain vehicle impacts prior to impact, i.e., pre-impact sensing. The impact sensor may be in communication with the computer. The impact sensor is configured to detect certain vehicle impacts. In other words, a “certain vehicle impact” is an impact of the type and/or magnitude for which inflation of the airbag is designed i.e., “certain” indicates the type and/or magnitude of the impact. The type and/or magnitude of such “certain vehicle impacts” may be pre-stored in the computer, e.g., a restraints control module. The impact sensor may be of any suitable type, for example, post contact sensors such as accelerometers, pressure sensors, and contact switches; and pre-impact sensors such as radar, LIDAR, and vision sensing systems. The vision sensing systems may include one or more cameras, CCD image sensors, CMOS image sensors, etc. The impact sensor may be located at numerous points in or on the vehicle 10.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1.-3. (canceled)

4. The vehicle seat as set forth in claim 20, wherein, in the inflated position, the middle portion is supported by the seat bottom, the first forward portion is supported by the middle portion, and the first wing portion is supported by the first forward portion.

5. The vehicle seat as set forth in claim 20, wherein the middle portion, the first forward portion, and the first wing portion are unitary.

6.-9. (canceled)

10. The vehicle seat as set forth in claim 20, wherein the seat bottom defines a leg area seat forward of the seat bottom, the leg area being configured to receive the legs of an occupant of the vehicle seat, the middle portion extending into the leg area, and the leg area being between the first forward portion and the seat bottom when the airbag is in the inflated position.

11.-19. (canceled)

20. A vehicle seat comprising:
a seat bottom having a first side, a second side, and a top surface extending from the first side to the second side, the seat bottom having a midline equidistantly spaced from the first side and the second side;
the seat bottom having a forward face extending downwardly directly from the top surface of the seat bottom; and
an airbag supported by the seat bottom and inflatable to an inflated position;
the airbag in the inflated position including a middle portion extending seat-forward from the forward face of the seat bottom in parallel with the midline;
the airbag in the inflated position including a first forward portion extending laterally from the middle portion, the first forward portion being spaced from the seat bottom, a top surface of the first forward portion in the inflated position being higher than the top surface of the seat bottom;
the airbag in the inflated position including a first wing portion spaced from the middle portion and extending seat-rearward from the first forward portion;
the airbag in the inflated position including a second forward portion extending laterally from the middle portion away from the first forward portion, the second forward portion being spaced from the seat bottom, a top surface of the second forward portion in the inflated position being higher than the top surface of the seat bottom;
the airbag in the inflated position including a second wing portion spaced from the middle portion and extending seat-rearward from the second forward portion; and
the airbag including an inflation chamber extending in the middle portion, the first forward portion, the first wing portion, the second forward portion, and the second wing portion;
the airbag includes a first tether extending from the first forward portion to the first wing portion, a second tether extending from the first forward portion to the middle portion, a third tether extending from the second forward portion to the second wing portion, and a fourth tether extending from the second forward portion to the middle portion.

21. (canceled)

22. The vehicle seat as set forth in claim 20, wherein the middle portion, the first forward portion, and the first wing portion, the second forward portion, and the second wing portion are unitary.

23. The vehicle seat as set forth in claim 20, wherein the middle portion of the airbag is on the midline.
